(19) United States
(12) Patent Application Publication
(10) Pub. No.: US 2026/0079234 A1
(43) Pub. Date: Mar. 19, 2026

(54) RADAR APPARATUS, SYSTEM, AND METHOD

(71) Applicant: MobilEye Vision Technologies Ltd., Jerusalem (IL)

(72) Inventors: Nati Dinur, Atlit (IL); Moshe Teplitsky, Tel-Aviv (IL); Mordechai Moti Lugassi, Giv'at Shmuel (IL)

(73) Assignee: MobilEye Vision Technologies Ltd., Jerusalem (IL)

(21) Appl. No.: 19/255,402

(22) Filed: Jun. 30, 2025

Related U.S. Application Data
(60) Provisional application No. 63/696,808, filed on Sep. 19, 2024.

(51) Int. Cl. G01S 7/292; G01S 13/931

(52) U.S. Cl. CPC G01S 7/292; G01S 13/931

(57) ABSTRACT

For example, an apparatus may include an input to receive digital radar Receive (Rx) information corresponding to radar Rx signals, the digital radar Rx information having a first number-of-bits-per-sample; and a noise-shaping quantizer configured to generate quantized radar Rx information by quantizing the digital radar Rx information. For example, the quantized radar Rx information may have a second number-of-bits-per-sample less than the first number-of-bits-per-sample. For example, the noise-shaping quantizer may be configured to generate the quantized radar Rx information having a non-uniform quantization noise spectrum, which has a non-uniform distribution in a frequency domain. For example, the apparatus may include an output to provide the quantized radar Rx information.

### CROSS-REFERENCE

This application claims the benefit of and priority from U.S. Provisional Patent Application No. 63/696,808, entitled “RADAR APPARATUS, SYSTEM, AND METHOD”, filed Sep. 19, 2024, the entire disclosure of which is incorporated herein by reference.

### BACKGROUND

Various types of devices and systems, for example, autonomous and/or robotic devices, e.g., autonomous vehicles and robots, may be configured to perceive and navigate through their environment using sensor data of one or more sensor types.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a system, in accordance with some demonstrative aspects.

FIG. 11 is a schematic illustration of a noise-shaping quantizer and a low-pass filter, in accordance with some demonstrative aspects.

FIG. 12 is a schematic illustration of a system, in accordance with some demonstrative aspects.

FIG. 13 is a schematic flow chart illustration of a method of generating quantized radar Rx information, in accordance with some demonstrative aspects.

FIG. 14 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, aspect, or design described herein as “exemplary” or “demonstrative” is not necessarily to be construed as preferred or advantageous over other aspects, aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances.

Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHZ, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

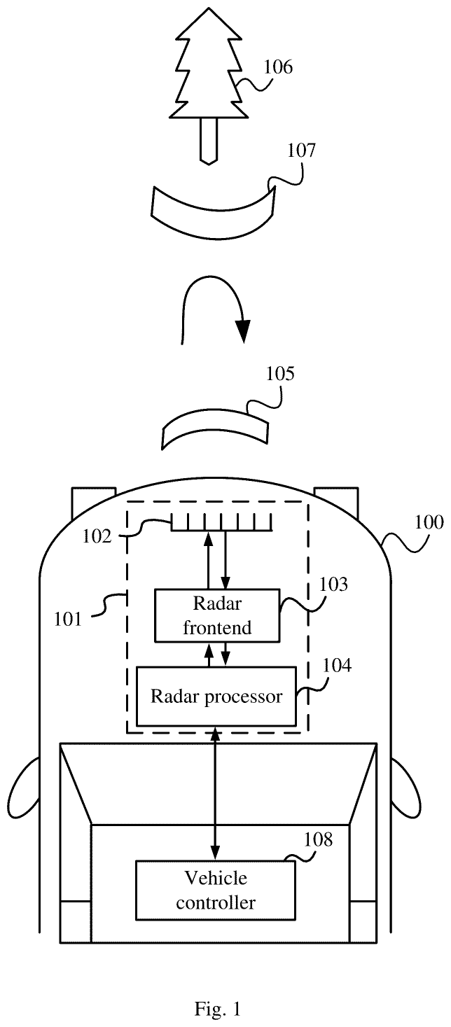

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may be configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identify a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

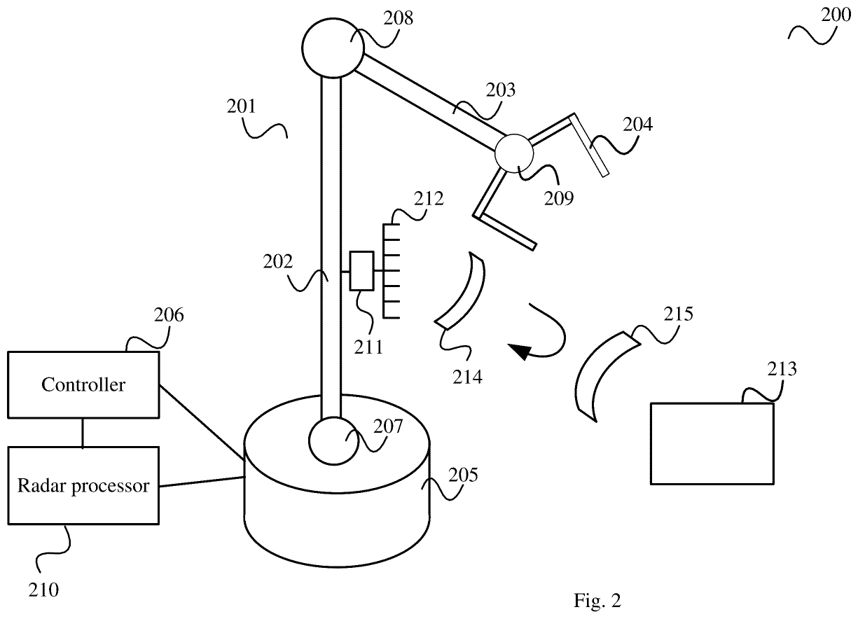

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e., actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

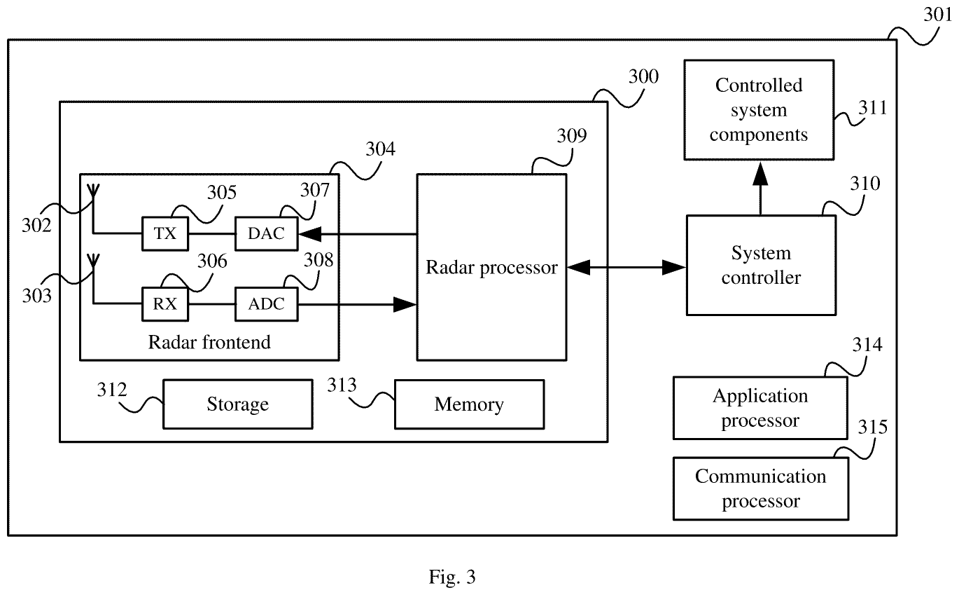

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

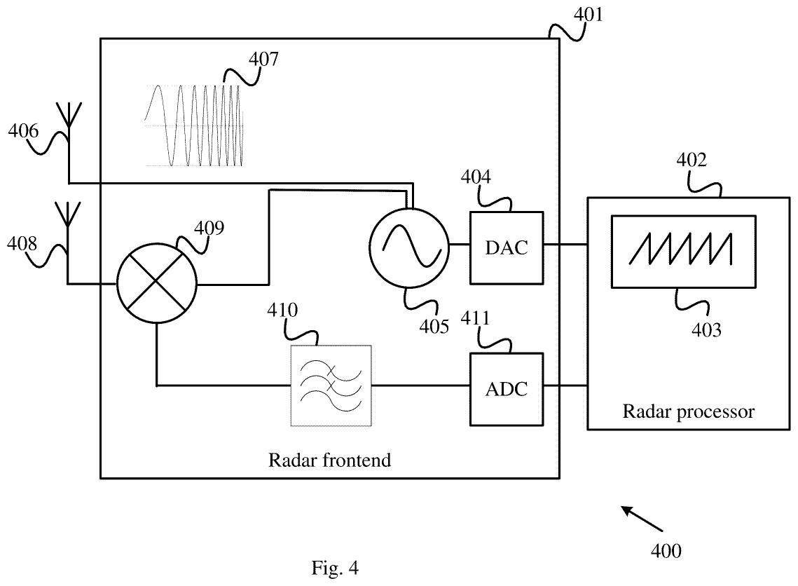

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

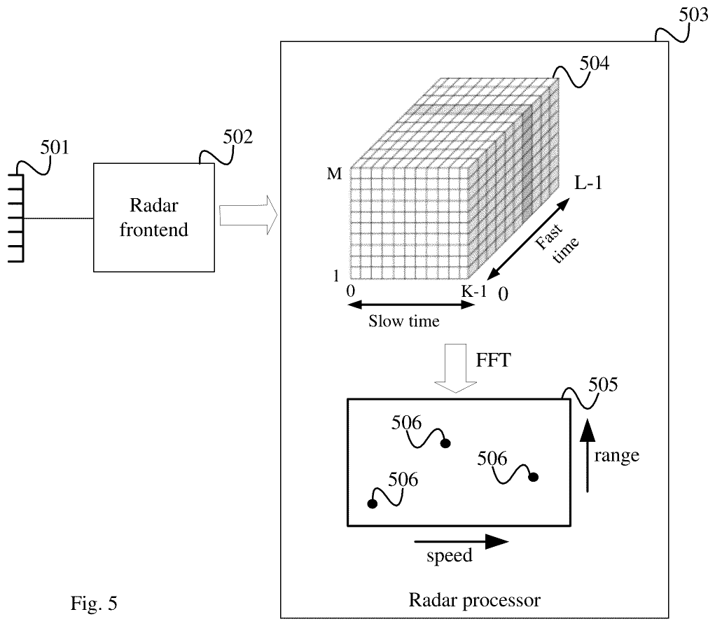

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

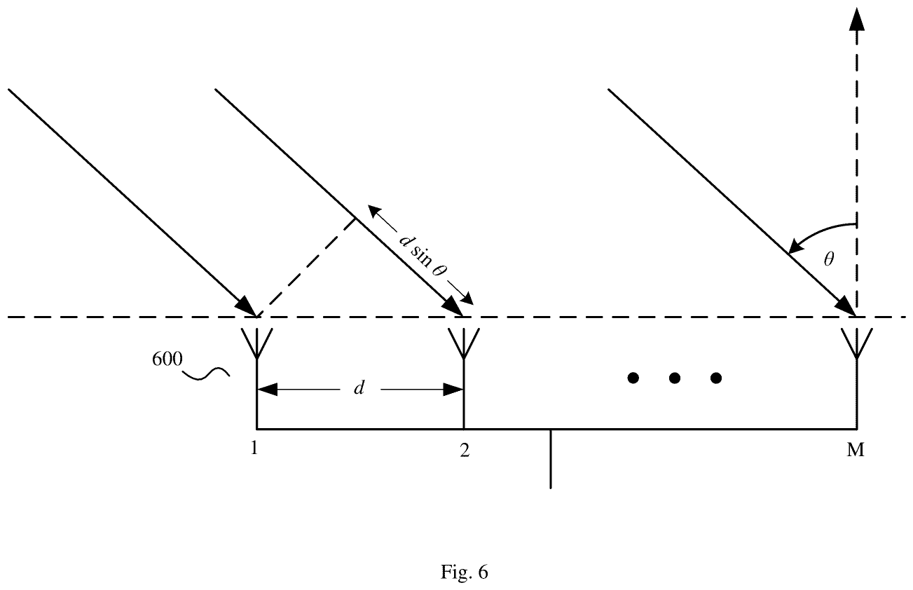

Reference is made to FIG. 6, which schematically illustrates an angle-determination scheme, which may be implemented to determine Angle of Arrival

(AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

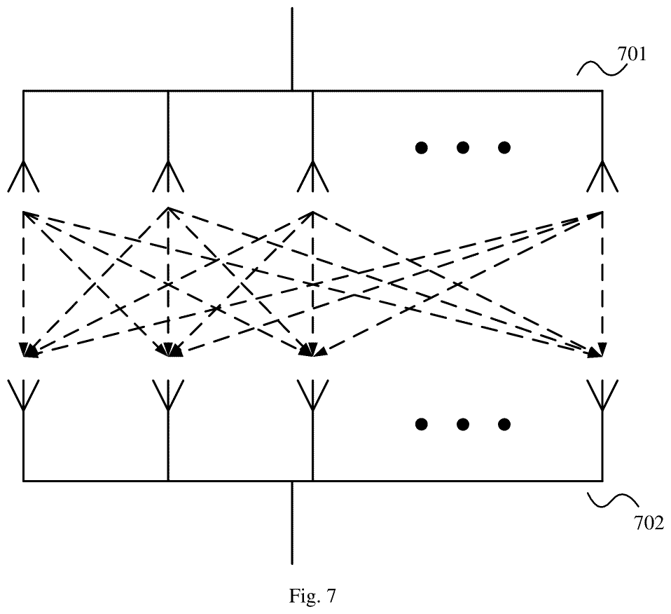

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

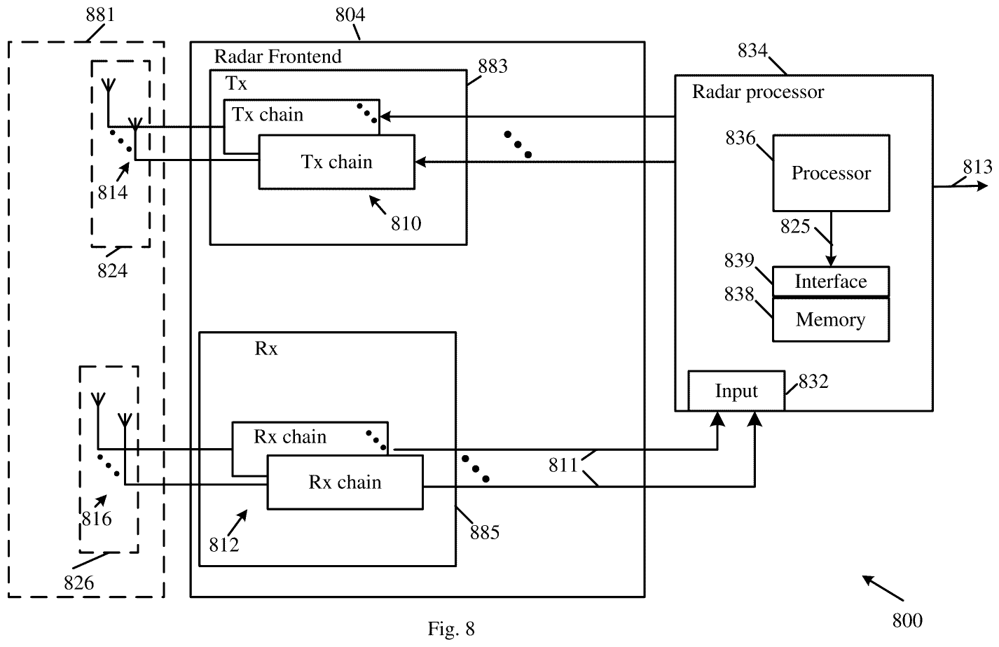

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, Signal to Noise Ratio (SNR) estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

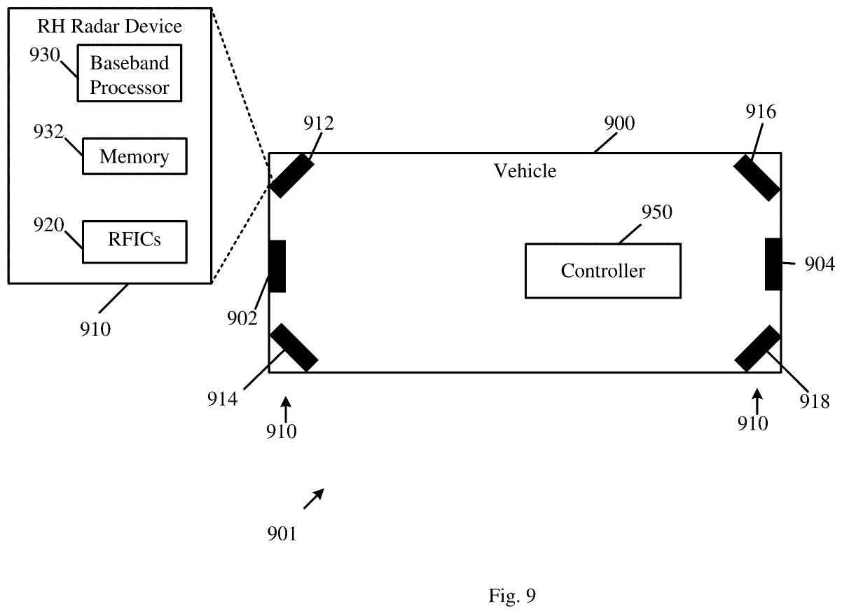

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, the plurality of RFICs 920 may be operable to form a MIMO radar antenna, for example, including one or more Tx antenna arrays and one or more Rx antenna arrays.

In some demonstrative aspects, a radar device, e.g., as described above with reference to FIGS. 1-9, may be configured to implement one or more operations and/or functionalities of a noise shaping quantization mechanism, e.g., as described below.

In some demonstrative aspects, the noise shaping quantization mechanism may be configured to provide a technical solution to support noise shaping quantization, e.g., efficient noise shaping quantization, for digital MIMO radars, for example, for digital automotive MIMO radars, e.g., as described below.

In some demonstrative aspects, the noise shaping quantization mechanism may be configured to provide a technical solution to support noise shaping quantization, e.g., efficient noise shaping quantization, for fully digital MIMO radars, e.g., as described below.

In some demonstrative aspects, the noise shaping quantization mechanism may be configured to provide a technical solution to address one or more technical aspects of systems utilizing a a communication interconnect, e.g., Serializer/Deserializer (SerDes), and/or a Double Data Rate (DDR) memory, which may be bottlenecks for some modern MIMO radars, e.g., as described below.

For example, some modern digital radars, e.g., fully digital MIMO radars, may generate significantly higher data rates than classic analog de-chirp radars.

For example, a speed of a communication interconnect, e.g., an available automotive grade interconnect, may not be sufficient for some implementations, which may result in a requirement to buffer data communicated over the communication interconnect, e.g., in order to reduce an effective data rate of the data communicated over the communication interconnect.

In one example, a communication interconnect may support a predefined data rate, e.g., a data rate greater than 10 Giga-bits-per second (Gbps), a data rate of about 20 Gbps, a data rate of about 30 Gbps, or any other data rate.

In one example, a radar Digital Frontend (DFE) may generate digital data at a rate of about 280 Mega samples per second (Msps), e.g., with 22 bits per sample, for example, across 6 channels, which may result in a data rate, which may surpass the data rate limit of the communication interconnect.

In another example, a radar DFE may generate digital data at a rate of about 250 Msps, e.g., with 16 bits per sample, for example, across 16 channels, which may result in a data rate of about 64 Gbps. For example, this data rate may surpass the data rate limit of the communication interconnect.

According to these examples, there may be a need to implement a buffer to buffer the digital data from the radar DFE, for example, in order to manage an effective data rate provided to the communication interconnect, in case the bandwidth of the communication interconnect is not sufficient to support the data rate of the digital data provided by the radar DFE.

For example, a memory, e.g., a DDR memory, may be used to store range and Doppler high-volume data. For example, an output data rate of a Cross Correlator (XCORR) may be significantly higher than a bandwidth of the DDR, which may be used to store an output of the XCORR. According to this example, there may be a need to implement an instantaneous range compression scheme, for example, to manage an effective data rate provided to the DDR.

For example, uniform quantization techniques may be implemented to decrease the data rate required for transmission over the communication interconnect. However, uniform quantization may significantly raise the noise level, and/or may decrease a sensitivity of the radar, e.g., by up to 3 dB or any other value.

For example, a predictive lossy compression technique may be applied using a Differential pulse-code modulation (DPCM) mechanism. However, implementation of the DPCM mechanism may increase complexity. For example, an encoding procedure according to the predictive lossy compression technique may require implementation of a Lloyd-Max quantizer (LMQ), e.g., in addition to a prediction error filter. For example, the LMQ may include a nonuniform quantizer, which may be optimized for a Gaussian distribution. For example, a decoding procedure according to the predictive lossy compression technique may require modification of range Doppler Hardware (HW). Accordingly, implementation of the encoding procedure according to the predictive lossy compression technique may not be compatible with existing range Doppler hardware, and may require additional post-processing and/or verification.

In some demonstrative aspects, a radar device, e.g., as described above with reference to FIGS. 1-9, may be configured to implement one or more operations and/or functionalities of a noise shaping quantization mechanism, which may be configured to provide technical solution to address the communication interconnect bottleneck, e.g., as described below.

In some demonstrative aspects, the noise shaping quantization mechanism may be configured to provide a technical solution to avoid a communication interconnect bottleneck, for example, even in case a communication interconnect supporting a relatively low data rate is implemented, e.g., as described below.

In some demonstrative aspects, the noise shaping quantization mechanism may be configured to utilize range processing, for example, to serve as an effective low-pass filter, which may introduce significant correlation and quantization noise coloring, e.g., as described below.

In some demonstrative aspects, the noise shaping quantization mechanism may be configured to provide a technical solution to provide quantized data, which may be quantized based on a low-pass filter, which may be implemented by a range-Doppler processor to process the quantized data, e.g., as described below.

In some demonstrative aspects, the noise shaping quantization mechanism may be configured, for example, to take advantage of a reordering capability of Linear Time-Invariant (LTI) filter operations, e.g., as described below.

For example, the noise shaping quantization mechanism may be configured to provide a technical solution, which may take advantage of an effect of the low-pass filter of the range-Doppler processor, for example, to substantially lower the quantization noise variance at the range processing output, for example, due to spectral shaping of a quantization error, e.g., as described below.

For example, the noise shaping quantization mechanism may be configured to utilize a high-pass filter, e.g., an optimized high-pass filter, which may be configured to push quantizing noise to higher frequencies, which may be removed, for example, by the range-processing low pass filter, e.g., as described below.

In some demonstrative aspects, a radar device, e.g., as described above with reference to FIGS. 1-9, may be configured to implement one or more operations and/or functionalities of a noise shaping quantization mechanism, which may be configured, for example, to provide a technical solution to support an improved, e.g., optimized, communication interconnect rate.

For example, the noise shaping quantization mechanism may be configured to provide a technical solution to decrease a quantization variance, which may support a more aggressive quantization. For example, the more aggressive quantization may support a significant reduction in the communication interconnect rate, for example, from 11 bits per component to a lower number of bits per component, or any other rate, e.g., as described below.

For example, this improvement in the communication interconnect data rate may have a big impact on chip memory requirements, board complexity, and/or a number of interconnect cores, which may consequently have a significant effect on cost and/or power consumption of the radar device.

In some demonstrative aspects, a radar device, e.g., as described above with reference to FIGS. 1-9, may be configured to implement one or more operations and/or functionalities of a noise shaping quantization mechanism, which may be configured, for example, to provide a technical solution to support a streamlined compatibility with existing range-Doppler processing HW.

For example, the noise shaping quantization mechanism may be implemented to provide a technical solution, which is compatible with existing range-Doppler processing hardware, and which does not require additional post-processing from the range-Doppler processing HW, thus ensuring efficiency and/or maintaining low complexity.

In some demonstrative aspects, a radar device, e.g., as described above with reference to FIGS. 1-9, may be configured to implement one or more operations and/or functionalities of a noise shaping quantization mechanism, which may be configured, for example, to provide a technical solution to reduce, or even eliminate, the use of communication interconnect buffers, which may otherwise be approximately in the megabyte range, e.g., for each receive (Rx) channel.

In some demonstrative aspects, a radar device, e.g., as described above with reference to FIGS. 1-9, may be configured to implement one or more operations and/or functionalities of a noise shaping quantization mechanism, which may provide an improved SNR, e.g., a low noise level, while utilizing a low communication interconnect rate.

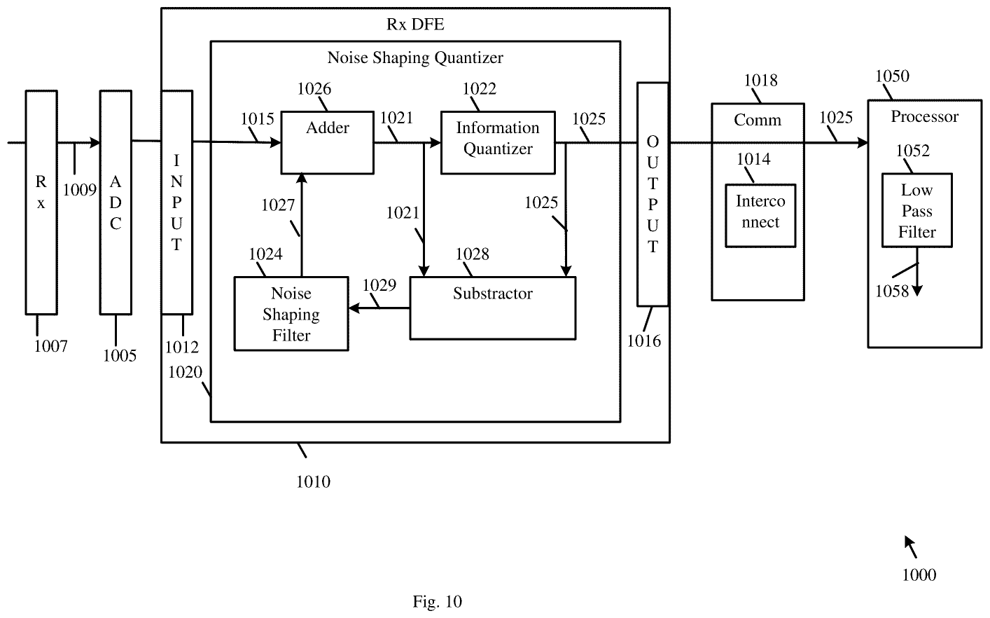

Reference is made to FIG. 10, which schematically illustrates a system 1000, in accordance with some demonstrative aspects.

In some demonstrative aspects, one or more elements of the system 1000 may be implemented by a radar device, e.g., radar device 800 (FIG. 8) or radar device 910 (FIG. 9), and/or a radar system, e.g., radar system 901 (FIG. 9).

In some demonstrative aspects, one or more elements of system 1000 may be configured to implement one or more operations and/or functionalities of a noise shaping quantization mechanism, e.g., as described below.

In some demonstrative aspects, system 1000 may include a plurality of Rx antennas 1007, e.g., as described below.

For example, Rx antennas 816 (FIG. 8) of MIMO antenna array 881 (FIG. 8) may include the plurality of Rx antennas 1007, and/or may perform one or more operations and/or functionalities of the plurality of Rx antennas 1007.

In some demonstrative aspects, the plurality of Rx antennas 1007 may be configured to receive radar Rx signals 1009, e.g., as described below.

In some demonstrative aspects, system 1000 may include an ADC 1005, which may be configured to convert analog radar Rx information of the radar Rx signals 1009 into digital radar Rx information 1015, e.g., as described below.

In some demonstrative aspects, the digital radar Rx information 1015 may have a sample rate of at least 250 Msps, e.g., as described below.

In some demonstrative aspects, the digital radar Rx information 1015 may have a sample rate of at least 550 Msps, e.g., as described below.

In some demonstrative aspects, the digital radar Rx information 1015 may have a sample rate of at least 1000 Msps, e.g., as described below.

In other aspects, the digital radar Rx information 1015 may have any other suitable sample rate.

In some demonstrative aspects, the digital radar Rx information 1015 may have a data rate greater than 25 Gbps, e.g., as described below.

In some demonstrative aspects, the digital radar Rx information 1015 may have a data rate equal to or greater than 30 Gbps, e.g., as described below.

In some demonstrative aspects, the digital radar Rx information 1015 may have a data rate equal to or greater than 35 Gbps, e.g., as described below.

In some demonstrative aspects, the digital radar Rx information 1015 may have a data rate equal to or greater than 40 Gbps, e.g., as described below.

In other aspects, the digital radar Rx information 1015 may have any other suitable data rate.

In some demonstrative aspects, system 1000 may include an Rx Digital Front End (DFE) 1010, which may be configured to process the digital radar Rx information 1015 of the radar Rx signals 1009, e.g., as described below.

In some demonstrative aspects, as shown in FIG. 10, ADC 1005 and Rx DFE 1010 may be implemented as separate elements of system 1000. In other aspects, ADC 1005 may be implemented as part of Rx DFE 1010.

In some demonstrative aspects, Rx DFE 1010 may be configured to generate quantized radar Rx information 1025, for example, based on the digital radar Rx information 1015, e.g., as described below.

In some demonstrative aspects, Rx DFE 1010 may include an input 1012, which may be configured to receive the digital radar Rx information 1015 corresponding to the radar Rx signals 1009, e.g., as described below.

In some demonstrative aspects, input 1012 may include any suitable input interface, input unit, input module, input component, input circuitry, memory interface, memory access unit, memory writer, digital memory unit, bus interface, processor interface, or the like, which may be capable of inputting the digital radar Rx information 1015 to a memory, a processor, and/or any other suitable component to handle the digital radar Rx information 1015.

In some demonstrative aspects, the digital radar Rx information 1015 may have a first number-of-bits-per-sample, e.g., as described below.

In some demonstrative aspects, Rx DFE 1010 may include a noise-shaping quantizer 1020, which may be configured to generate the quantized radar Rx information 1025, for example, by quantizing the digital radar Rx information 1015, e.g., as described below.

In some demonstrative aspects, noise-shaping quantizer 1020 may be configured to provide the quantized radar Rx information 1025 having a second number-of-bits-per-sample, which may be less than the first number-of-bits-per-sample of the digital radar Rx information 1015, e.g., as described below.

In some demonstrative aspects, the noise-shaping quantizer 1020 may be configured to generate the quantized radar Rx information 1025 having, for example, a non-uniform quantization noise spectrum, which has a non-uniform distribution in a frequency domain, e.g., as described below.

In some demonstrative aspects, Rx DFE 1010 may include an output 1016, which may be configured to provide the quantized radar Rx information 1025, e.g., as described below.

In some demonstrative aspects, Rx DFE 1010 may be configured to provide the quantized radar Rx information 1025, for example, via output 1016, e.g., as described below.

In some demonstrative aspects, output 1016 may include any suitable output interface, output unit, output module, output component, output circuitry, memory interface, memory access unit, memory writer, digital memory unit, bus interface, processor interface, or the like, which may be capable of outputting the quantized radar Rx information 1025 to a memory, a processor, and/or any other suitable component to handle the quantized radar Rx information 1025.

In some demonstrative aspects, the quantized radar Rx information 1025 may be configured, for example, such that there may be a difference of 2 or more samples between the first number-of-bits-per-sample of the digital radar Rx information 1015 and the second number-of-bits-per-sample of the quantized radar Rx information 1025, e.g., as described below.

In some demonstrative aspects, the quantized radar Rx information 1025 may be configured, for example, such that there may be a difference of 3 samples between the first number-of-bits-per-sample of the digital radar Rx information 1015 and the second number-of-bits-per-sample of the quantized radar Rx information 1025, e.g., as described below.

In some demonstrative aspects, the quantized radar Rx information 1025 may be configured, for example, such that there may be a difference of 4 samples between the first number-of-bits-per-sample of the digital radar Rx information 1015 and the second number-of-bits-per-sample of the quantized radar Rx information 1025, e.g., as described below.

In some demonstrative aspects, the quantized radar Rx information 1025 may be configured, for example, such that there may be a difference of 5 samples between the first number-of-bits-per-sample of the digital radar Rx information 1015 and the second number-of-bits-per-sample of the quantized radar Rx information 1025, e.g., as described below.

In other aspects, the quantized radar Rx information 1025 may be configured, for example, such that there may be any other difference between the first number-of-bits-per-sample of the digital radar Rx information 1015 and the second number-of-bits-per-sample of the quantized radar Rx information 1025.

In some demonstrative aspects, noise-shaping quantizer 1020 may be configured to generate the quantized radar Rx information 1025, for example, such that the non-uniform quantization noise spectrum of the quantized radar Rx information 1025 may be based, for example, on a predefined filter frequency response, e.g., as described below.

In some demonstrative aspects, noise-shaping quantizer 1020 may be configured to generate the quantized radar Rx information 1025, for example, such that the non-uniform quantization noise spectrum of the quantized radar Rx information 1025 may be based, for example, on a predefined low-pass filter frequency response, e.g., as described below.

In some demonstrative aspects, noise-shaping quantizer 1020 may be configured to generate the quantized radar Rx information 1025, for example, such that the non-uniform quantization noise spectrum of the quantized radar Rx information 1025 may have a form of a high-pass filter frequency response, e.g., as described below.

In some demonstrative aspects, a high-pass cutoff frequency of the high-pass spectrum distribution may be based, for example, on a low-pass filter cutoff frequency of a low-pass filter frequency response to be applied to the quantized radar Rx information, e.g., as described below.

In other aspects, noise-shaping quantizer 1020 may be configured to generate the quantized radar Rx information 1025, for example, such that the non-uniform quantization noise spectrum of the quantized radar Rx information 1025 may be based on any other additional or alternative parameters and/or criteria.

In some demonstrative aspects, noise-shaping quantizer 1020 may be configured to generate the quantized radar Rx information 1025, for example, such that the non-uniform quantization noise spectrum of the quantized radar Rx information 1025 may be based, for example, on a filter frequency response to be applied to the quantized radar Rx information 1025, e.g., as described below.

In some demonstrative aspects, noise-shaping quantizer 1020 may be configured to generate the quantized radar Rx information 1025, for example, such that a filter-convolved noise level of a filter-convolved noise spectrum may be less than a quantization-spectrum noise level of the non-uniform quantization noise spectrum of the quantized radar Rx information 1025, e.g., as described below.

In some demonstrative aspects, the filter-convolved noise spectrum may include a convolution of the non-uniform quantization noise spectrum of the quantized radar Rx information 1025 with the filter frequency response to be applied to the quantized radar Rx information 1025, e.g., as described below.

In some demonstrative aspects, the non-uniform quantization noise spectrum of the quantized radar Rx information 1025 may be configured, for example, such that a convolution of the non-uniform quantization noise spectrum of the quantized radar Rx information 1025 with the filter frequency response is to result in a substantially uniform filter-convolved noise spectrum, e.g., as described below.

In other aspects, the non-uniform quantization noise spectrum of the quantized radar Rx information 1025 may be configured based on any other additional criteria corresponding to the filter frequency response and/or filter-convolved noise spectrum.

In some demonstrative aspects, the filter frequency response to be applied to the quantized radar Rx information 1025 may include a range-processing filter frequency response to be applied to the quantized radar Rx information 105, for example, for radar range processing, e.g., as described below.

In some demonstrative aspects, the filter frequency response to be applied to the quantized radar Rx information 1025 may include a low-pass filter frequency response, e.g., as described below.

In some demonstrative aspects, system 1000 may include a processor 1050, which may be configured to process the quantized radar Rx information 1025, for example, using a low-pass filter 1052, e.g., as described below.

In some demonstrative aspects, low-pass filter 1052 may be configured to apply to the quantized radar Rx information 1025 a range-processing filter frequency response, for example, for radar range processing, e.g., as described below.

In some demonstrative aspects, low-pass filter 1052 may be configured to apply a low-pass filter response to the quantized radar Rx information 1025, for example, to provide filtered information 1058, e.g., as described below.

In some demonstrative aspects, system 1000 may include a communication interface 1018, which may be configured to transfer the quantized radar Rx information 1025 to the processor 1050, e.g., as described below.

In some demonstrative aspects, the communication interface 1018 may include a communication interconnect 1014, for example, a Serializer/Deserializer (SERDES) interface or the like, e.g., as described below. In other aspects, the communication interface 1018 may include any other suitable additional or alternative type of communication interface.

In some demonstrative aspects, the non-uniform quantization noise spectrum of the quantized radar Rx information 1025 may be based, for example, on a filter frequency response to be applied by the processor 1050 to the quantized radar Rx information 1025, e.g., as described below.

In some demonstrative aspects, the noise-shaping quantizer 1020 may be configured to generate the quantized radar Rx information 1025, for example, such that the non-uniform quantization noise spectrum of quantized radar Rx information 1025 may be based, for example, on the low-pass filter frequency response of the low-pass filter 1052, e.g., as described below.

In some demonstrative aspects, the non-uniform quantization noise spectrum of quantized radar Rx information 1025 may be configured, for example, based on one or more criteria corresponding to a noise spectrum of the filtered information 1058 provided by low-pass filter 1052, e.g., as described below.

In some demonstrative aspects, the non-uniform quantization noise spectrum of quantized radar Rx information 1025 may be configured, for example, such that a filter-convolved noise level of a filter-convolved noise spectrum may be less than a quantization-spectrum noise level of the non-uniform quantization noise spectrum of quantized radar Rx information 1025, e.g., as described below.

In some demonstrative aspects, the filter-convolved noise spectrum may include a convolution of the non-uniform quantization noise spectrum of quantized radar Rx information 1025 with the filter frequency response of the low-pass filter 1052, e.g., as described below.

In some demonstrative aspects, the non-uniform quantization noise spectrum of quantized radar Rx information 1025 may be configured, for example, such that a convolution of the non-uniform quantization noise spectrum of quantized radar Rx information 1025 with the filter frequency response of the low-pass filter 1052 may result in a substantially uniform filter-convolved noise spectrum, e.g., as described below.

In some demonstrative aspects, the non-uniform quantization noise spectrum of quantized radar Rx information 1025 may have a high-pass spectrum distribution, which may have a form of a high-pass filter frequency response, which may be configured, for example, based on the low-pass filter frequency response of the low-pass filter 1052, e.g., as described below.

In some demonstrative aspects, a high-pass cutoff frequency of the high-pass spectrum distribution may be based, for example, on a low-pass filter cutoff frequency of the low-pass filter frequency response of low-pass filter 1052, e.g., as described below.

In some demonstrative aspects, the noise-shaping quantizer 1020 may include an information quantizer 1022, which may be configured to generate the quantized radar Rx information 1025, for example, by quantizing a quantizer input 1021, e.g., as described below.

In some demonstrative aspects, the noise-shaping quantizer 1020 may include a noise-shaping filter 1024, which may be configured to generate filtered quantization noise 1027, for example, by applying a noise-shaping filter frequency response to a quantization error 1029 of the information quantizer 1022, e.g., as described below.

In some demonstrative aspects, the quantizer input 1021 of the noise-shaping quantizer 1020 may be based, for example, on the filtered quantization noise 1027 and the digital radar Rx information 1015, e.g., as described below.

In some demonstrative aspects, the noise-shaping quantizer 1020 may include an adder 1026, which may be configured to provide the quantizer input 1021, for example, by summation of the filtered quantization noise 1027 and the digital radar Rx information 1015, e.g., as described below.

In some demonstrative aspects, the noise-shaping quantizer 1020 may include a subtractor 1028, which may be configured to provide the quantization error 1029, for example, by subtraction of the quantizer input 1021 from the quantized radar Rx information 1025, e.g., as described below.

In some demonstrative aspects, the information quantizer 1022 may include a uniform quantizer, which may be configured to generate the quantized radar Rx information 1025, for example, according to a uniform quantization scheme, e.g., as described below.

In other aspects, the information quantizer 1022 may include any other additional and/or alternative type of quantizer, which may be configured to generate the quantized radar Rx information 1025, for example, according to any other additional and/or alternative quantization scheme.

In some demonstrative aspects, the noise-shaping filter 1024 may include a non-linear filter, e.g., as described below.

In some demonstrative aspects, the noise-shaping filter 1024 may include a non-linear recursive filter, e.g., as described below.

In other aspects, the noise-shaping filter 1024 may include any other additional and/or alternative type of filter.

In some demonstrative aspects, the noise-shaping filter frequency response of the noise-shaping filter 1024 may be based, for example, on a low-pass filter frequency response to be applied to the quantized radar Rx information 1025, for example, by the low-pass filter 1052, e.g., as described below.

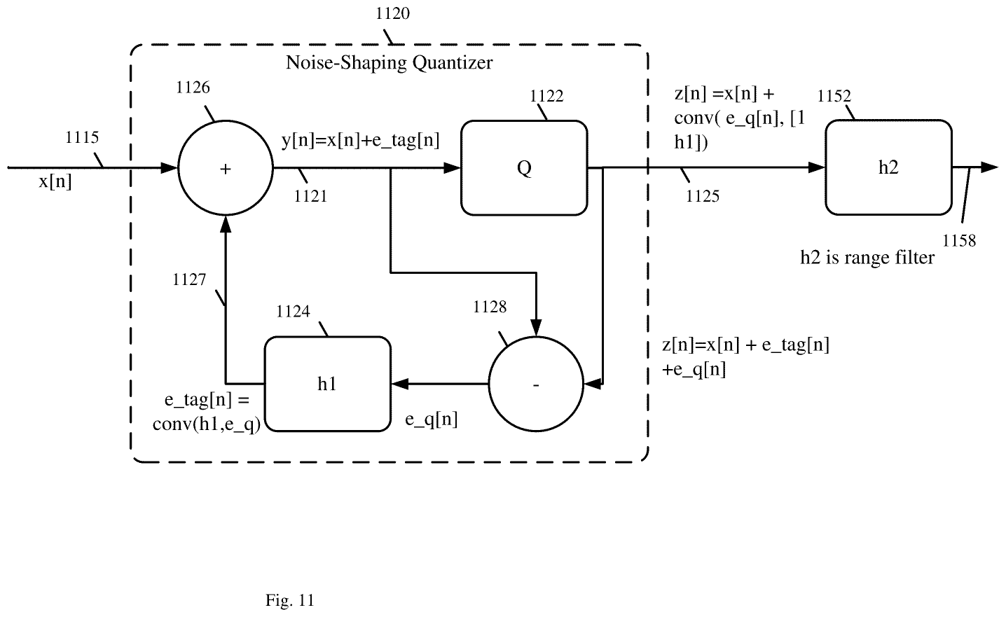

Reference is made to FIG. 11, which schematically illustrates a noise-shaping quantizer 1120 and a low-pass filter 1152, in accordance with some demonstrative aspects.

For example, noise-shaping quantizer 1020 (FIG. 10) may include one or more elements of noise-shaping quantizer 1120, and/or may perform one or more operations and/or functionalities of noise-shaping quantizer 1120; and/or low-pass filter 1052 (FIG. 10) may include one or more elements of low-pass filter 1152, and/or may perform one or more operations and/or functionalities of low-pass filter 1152.

In some demonstrative aspects, noise-shaping quantizer 1120 may be configured to generate quantized radar Rx information 1125, denoted z[n], for example, by quantizing digital radar Rx information 1115, denoted x[n].

In one example, digital radar Rx information 1115 may include an Rx DFE complex signal.

In some demonstrative aspects, low-pass filter 1152 may be configured to apply a low-pass filter frequency response, dented h2, to the quantized radar Rx information 1125, for example, to generate filtered radar information 1158.

In some demonstrative aspects, a noise spectrum of the filtered radar information 1158 may be based, for example, on a convolution of a non-uniform quantization noise spectrum of the digital radar Rx information 1125 with the filter frequency response h2 of low-pass filter 1152.

In some demonstrative aspects, as shown in FIG. 11, the noise-shaping quantizer 1120 may include an information quantizer 1122, which may be configured to generate the quantized radar Rx information 1125, e.g., z[n], for example, by quantizing a quantizer input 1121, denoted y[n].

In some demonstrative aspects, as shown in FIG. 11, the noise-shaping quantizer 1120 may include a noise-shaping filter 1124, which may be configured to generate filtered quantization noise 1127, denoted e_tag[n], for example, by applying a noise-shaping filter frequency response, denoted h1, to a quantization error 1129, denoted e_q[n], of the information quantizer 1122, e.g., e_tag[n]=conv(h1,e_q[n]).

In some demonstrative aspects, as shown in FIG. 11, the noise-shaping quantizer 1120 may include an adder 1126, which may be configured to provide the quantizer input 1121, e.g., y[n], for example, by summation of the filtered quantization noise 1127, e.g., e_tag[n], and the digital radar Rx information 1115, e.g., x[n], for example, y[n]=x[n]+e_tag[n].

In some demonstrative aspects, as shown in FIG. 11, the information quantizer 1122 may be configured to generate the quantized radar Rx information 1125, e.g., z[n], for example, by quantizing the quantizer input 1121, e.g., y[n], for example, z[n]=x[n]+conv(e_q[n], [1 h1]).

In some demonstrative aspects, as shown in FIG. 11, the noise-shaping quantizer 1120 may include a subtractor 1128, which may be configured to provide the quantization error 1129, e.g., e_q[n], for example, by subtraction of the quantizer input 1121, e.g., y[n], from the quantized radar Rx information 1125, e.g., z[n]. For example, subtractor 1128 may be configured to provide the quantization error e_q[n], for example, by subtraction of y[n] from z[n], e.g., e_q[n]={x[n]+conv(e_q[n], [1 h1])}−{x[n]+e_tag[n]}.

In some demonstrative aspects, the quantization error 1129 may be determined, e.g., as follows:

$$\begin{matrix}{e}_{q} [ n ] = Q ( x [ n ] + {e}_{tag} [ n ] ) - ( x [ n ] + {e}_{tag} [ n ] ) \\ = f ( x [ n ] , {e}_{q} [ n - 1 ] , {e}_{q} [ n - 2 ] , … , {e}_{q} [ n - L ] )\end{matrix}$$

wherein f denotes a nonlinear function, which may be related to a difference between the quantized version of x[n]+e_{tag}[n], e.g., the quantized radar Rx information 1125, and the non-quantized version of x[n]+e_{tag}[n], e.g., at the quantizer input 1121.

In some demonstrative aspects, an analytical solution may be developed to provide an improved, e.g., an optimal, noise shaping filter implementation for noise shaping quantizer 1120, e.g., as described below.

In some demonstrative aspects, the analytical solution for the optimal filter implementation for noise shaping quantizer 1120 may be designed to reduce, e.g., minimize, quantization noise in a post-range output stage, e.g., at the filtered radar information 1158.

For example, the signal y[n] may be modeled, e.g., as follows:

$$y [ n ] = h [ n ] * x [ n ] = ( {h}_{1} [ n ] * {h}_{2} [ n ] ) * x [ n ] \qquad ( 1 )$$

wherein h[n]≙h₁[n]*h₂[n] and x[n] may include Independent and Identically Distributed (IID) white quantization noise.

For example, the following vectors may be defined:

$$\begin{matrix}X {=}^{Δ} {[ {x}_{1} , {x}_{2} , … , {x}_{L} ]}^{T} , \\ {h}_{1} {=}^{Δ} {[ {h}_{11} , {h}_{12} , … , {h}_{1 N} ]}^{T} , \\ {h}_{2} {=}^{Δ} {[ {h}_{21} , {h}_{22} , … , {h}_{2 M} ]}^{T} , \\ h {=}^{Δ} {[ {h}_{1} , {h}_{2} , … , {h}_{M + N - 1} ]}^{T} ,\end{matrix}$$

For example, the following matrix representation of Equation (1) may be determined, e.g., as follows:

$$y = Hx \qquad ( 2 )$$

wherein H denotes a convolution matrix of the vector h.

For example, it may be shown that E{∥y∥²}} is proportional to ∥h∥². Therefore, the term ∥h∥² may be minimized, for example, to minimize E{∥y∥²}.

For example, further to the concept of Equation (2), the vector h may be presented as follows: h=H₂h₁, where H₂ denotes the convolution matrix of h₂ with a size of (M+N−1)×N.

For example, ∥h∥² may be rewritten, e.g., as follows:

$${‖ h ‖}^{2} = {h}_{1}^{H} {H}_{2}^{H} {H}_{2} {h}_{1} \qquad ( 3 )$$

For example, the matrix

$${H}_{2}^{H} {H}_{2} .$$

with a size of N×N may have positive semi definite, and may be presented, for example, using Singular Value Decomposition (SVD), e.g., as follows:

$${H}_{2}^{H} {H}_{2} = {USU}^{H} ,$$

wherein U denotes an orthonormal matrix, and S denotes a diagonal matrix.

For example, Equation (3) may be rewritten as:

$${‖ h ‖}^{2} = {h}_{1}^{H} {USU}^{H} {h}_{1} \qquad ( 4 )$$

For example, the vector h₁ may be defined by linear combination of columns of the matrix U, e.g., as follows:

$${h}_{1} = Ua \qquad ( 5 )$$

wherein a=[a₁, a₂, . . . , a_{N}] denotes a vector of weights.

For example, Equation (5) may be substituted into Equation (4), e.g., as follows:

$${‖ h ‖}^{2} = {a}^{H} Sa$$

For example, a constraint on the vector of weights a may be defined, e.g., as follows:

$${a}^{H} u = 1$$

wherein u denotes a first row of the matrix U.

For example, this constraint on the vector of weights a may ensure that the first entry of the vector h₁ is equal to 1.

For example, an optimization problem to optimize the vector of weights a may be defined, e.g., as follows:

$$\begin{matrix}{a}_{opt} = {arg min}_{a} \{ {a}^{H} Sa \} \\ s . t . , {a}^{H} u = 1\end{matrix} \qquad ( 6 )$$

For example, a solution for this optimization problem may be determined, e.g., as follows:

$${a}_{opt} = \frac{{S}^{- 1} a}{{a}^{H} {S}^{- 1} a} \qquad ( 7 )$$

For example, an optimal filter, which may minimize the term E{∥y∥²} may be determined, for example, based on Equation (7), e.g., as follows:

$${h}_{1}^{opt} = {Ua}_{opt} \qquad ( 8 )$$

According to the above, the optimality of the solution may be validated, for example, by comparison to nonlinear least-squares numerical optimization.

In some demonstrative aspects, noise shaping quantizer 1120 may be configured to provide a technical solution to address one or more technical aspects of a recursive filter design, e.g., as described below.

For example, a recursive behavior of a noise shaping quantizer 1120 may have an effect on a Very Large Scale Integration (VLSI) implementation, e.g., similar to a nonlinear Infinite Impulse Response (IIR) filter:

$$\begin{matrix}{e}_{q} [ n ] = Q ( x [ n ] + {e}_{tag} [ n ] ) - ( x [ n ] + {e}_{tag} [ n ] ) \\ = f ( x [ n ] , {e}_{q} [ n - 1 ] , {e}_{q} [ n - 2 ] , … , {e}_{q} [ n - L ] )\end{matrix} \qquad ( 9 )$$

In some demonstrative aspects, a design of the noise shaping quantizer 1120 may be configured to support one or more sample rates, e.g., of the digital radar Rx information 1115. For example, shaping quantizer 1120 may be configured according to one or more processing requirements, which may be based on the one or more sample rates, e.g., as described below.

In some demonstrative aspects, noise shaping quantizer 1120 may be configured to support a first sampling rate mode, e.g., a medium sampling rate mode, which may support a “medium” sample rate, for example, a sample rate of up to about 500 Msps. In one example, the medium sample rate may be implemented, for example, for a Medium Radar Range (MRR) mode, e.g., having a sample rate of about 275 Msps. For example, noise shaping quantizer 1120 may be implemented according to a VLSI scheme, which may be configured to support, for example, pipeline processing, e.g., without a requirement for parallel processing.

In some demonstrative aspects, noise shaping quantizer 1120 may be configured to support a second sampling rate mode, e.g., a medium-high sampling rate mode, which may support a “medium-high” sample rate, for example, a sample rate of above 500 Msps. In one example, the medium-high sample rate may be implemented, for example, for a Short Medium Radar Range (SMRR) mode, e.g., having a sample rate of about 550 Msps. For example, noise shaping quantizer 1120 may be implemented according to a VLSI scheme, which may be configured to support, for example, parallel processing with a relatively low factor, e.g., a factor of 2 or any other suitable factor.

In some demonstrative aspects, noise shaping quantizer 1120 may be configured to support a third sampling rate mode, e.g., a high sampling rate mode, which may support a “high” sample rate, for example, a sample rate of above 800 Msps. In one example, the high sample rate may be implemented, for example, for a Short Radar Range (SRR) mode, e.g., having a sample rate of about 1100 Msps. For example, noise shaping quantizer 1120 may be implemented according to a VLSI scheme, which may be configured to support, for example, parallel processing with a relatively high factor, e.g., a factor of 4 or any other suitable factor.

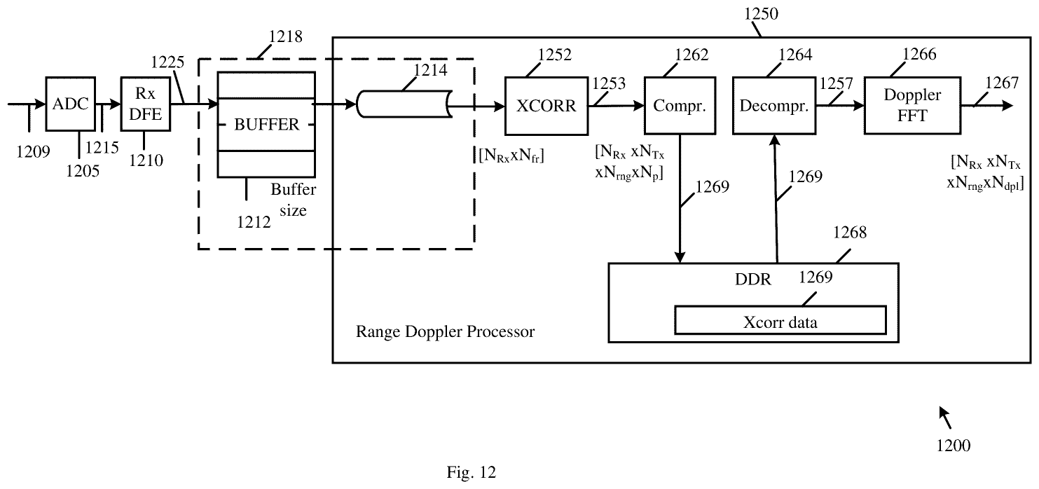

Reference is made to FIG. 12, which schematically illustrates a system 1200, in accordance with some demonstrative aspects. For example, system 1000 (FIG. 10) may include one or more elements of system 1200, and/or may perform one or more operations and/or functionalities of system 1200.

In some demonstrative aspects, one or more elements of system 1200 may be configured to implement one or more operations and/or functionalities of a noise shaping quantization mechanism, e.g., as described below.

In some demonstrative aspects, as shown in FIG. 12, system 1200 may include an ADC 1205, which may be configured to convert analog radar Rx information of radar Rx signals 1209 into digital radar Rx information 1215.

In some demonstrative aspects, the digital radar Rx information 1215 may have a sample rate of at least 250 Msps.

In some demonstrative aspects, the digital radar Rx information 1215 may have a data rate greater than 25 Gbps.

In some demonstrative aspects, as shown in FIG. 12, system 1200 may include an Rx DFE 1210, which may be configured to process the digital radar Rx information 1215 corresponding to the radar Rx signals 1209. For example, Rx DFE 1210 may include one or more elements of Rx DFE 1010 (FIG. 10), and/or may perform one or more operations and/or functionalities of Rx DFE 1010 (FIG. 10).

In some demonstrative aspects, Rx DFE 1210 may be configured to generate quantized radar Rx information 1225, for example, by quantizing the digital radar Rx information 1215, e.g., as described above.

In some demonstrative aspects, Rx DFE 1210 may include a noise-shaping quantizer, e.g., noise-shaping quantizer 1020 (FIG. 10), which may be configured to generate the quantized radar Rx information 1225, for example, by quantizing the digital radar Rx information 1215, e.g., as described above.

In some demonstrative aspects, the noise-shaping quantizer, e.g., noise-shaping quantizer 1020 (FIG. 10), may be configured to generate the quantized radar Rx information 1225 to have a number-of-bits-per-sample, which may be less than a number-of-bits-per-sample of the digital radar Rx information 1215, e.g., as described above.

In some demonstrative aspects, the quantized radar Rx information 1225 may be configured, for example, such that there may be a difference of 2 or more samples between the number-of-bits-per-sample of the digital radar Rx information 1215 and the number-of-bits-per-sample of the quantized radar Rx information 1225, e.g., as described above.

In some demonstrative aspects, the quantized radar Rx information 1225 may be configured, for example, such that there may be a difference of 3 samples between the number-of-bits-per-sample of the digital radar Rx information 1215 and the number-of-bits-per-sample of the quantized radar Rx information 1225, e.g., as described above.

In some demonstrative aspects, the quantized radar Rx information 1225 may be configured, for example, such that there may be a difference of 4 samples between the number-of-bits-per-sample of the digital radar Rx information 1215 and the number-of-bits-per-sample of the quantized radar Rx information 1225, e.g., as described above.

In some demonstrative aspects, the quantized radar Rx information 1225 may be configured, for example, such that there may be a difference of 5 samples between the number-of-bits-per-sample of the digital radar Rx information 1215 and the number-of-bits-per-sample of the quantized radar Rx information 1225, e.g., as described above.

In other aspects, the quantized radar Rx information 1225 may be configured, for example, such that there may be any other difference between the number-of-bits-per-sample of the digital radar Rx information 1215 and the number-of-bits-per-sample of the quantized radar Rx information 1225.

In some demonstrative aspects, as shown in FIG. 12, system 1200 may include a processor 1250, e.g., a range Doppler processor, which may be configured to perform Range-Doppler processing of the quantized radar Rx information 1225.

In some demonstrative aspects, system 1200 may include a communication interface 1218, which may be configured to transfer the quantized radar Rx information 1225 from the Rx DFE 1210 to the processor 1250, e.g., as described below.

In some demonstrative aspects, as shown in FIG. 12, the communication interface 1218 may include a communication interconnect 1214, e.g., a SERDES interface or the like.

In some demonstrative aspects, as shown in FIG. 12, the communication interconnect 1214 may be capable of supporting a maximal data rate, e.g., a maximal data rate of less than 40 Gbps, for example, less than 30 Gbps, or any other maximal data rate.

In some demonstrative aspects, a buffer 1212 may optionally be implanted, for example, to buffer the digital radar Rx information 1215, for example, to manage the data rate for communication over the communication interconnect 1214.

In some demonstrative aspects, as shown in FIG. 12, processor 1250 may include a range processor 1252, e.g., an (XCORR), which may be configured to generate range-processed data 1253, for example, based on the quantized radar Rx information 1225.

In some demonstrative aspects, range processor 1252 may include and/or may implement a low-pass filter, e.g., low-pass filter 1052 (FIG. 10), which may be configured to apply a low-pass filter frequency response to the quantized radar Rx information 1225, for example, for radar range processing.

In some demonstrative aspects, as shown in FIG. 12, processor 1250 may include a compressor 1262, which may be configured to compress the range-processed data 1233 into compressed range-processed data 1269.

In some demonstrative aspects, as shown in FIG. 12, processor 1250 may include, or may be associated with, a memory 1268, e.g., a DDR memory, which may be configured to store the compressed range-processed data 1269.

In some demonstrative aspects, as shown in FIG. 12, processor 1250 may include a decompressor 1264, which may be configured to decompress the compressed range-processed data 1269, for example, into decompressed range-processed data 1257, e.g., sustainably similar to the range-processed data 1253.

In some demonstrative aspects, as shown in FIG. 12, processor 1250 may include a Doppler processor 1266, e.g., a Doppler FFT processor, which may be configured to generate Doppler-processed data 1267, for example, based on the decompressed range-processed data 1257.

In some demonstrative aspects, Rx DFE 1210 may include a noise-shaping quantizer, e.g., noise-shaping quantizer 1020 (FIG. 10), which may be configured to generate the quantized radar Rx information 1225, for example, such that a non-uniform quantization noise spectrum of the quantized radar Rx information 1225 may be based, for example, on a filter frequency response to be applied to the quantized radar Rx information 1252 by the low-pass filter, e.g., low-pass filter 1052 (FIG. 10), implemented by XCORR processor 1252, e.g., as described above.

In some demonstrative aspects, the non-uniform quantization noise spectrum of the quantized radar Rx information 1225 may be configured, for example, such that a filter-convolved noise level of a filter-convolved noise spectrum of the range-processed data 1253 may be less than a quantization-spectrum noise level of the non-uniform quantization noise spectrum 1252. For example, the filter-convolved noise spectrum may include a convolution of the non-uniform quantization noise spectrum of the quantized radar Rx information 1252 with the filter frequency response of the low-pass filter, e.g., low-pass filter 1052 (FIG. 10), implemented by XCORR processor 1252, e.g., as described above.

In some demonstrative aspects, Rx DFE 1210 may implement the noise-shaping quantizer, e.g., noise-shaping quantizer 1020 (FIG. 10), for example, to provide a technical solution to support reducing or even eliminating a communication interconnect bottleneck for system 1200, for example, due to the data rate supported by communication interconnect 1214, for example, without performance degradation and/or with an improved SNR.

In some demonstrative aspects, Rx DFE 1210 may implement the noise-shaping quantizer, e.g., noise-shaping quantizer 1020 (FIG. 10), for example, to provide a technical solution to support reducing, e.g., sustainably reducing, a size of buffer 1212, or even eliminating usage of buffer 1212.

In some demonstrative aspects, Rx DFE 1210 may implement the noise-shaping quantizer, e.g., noise-shaping quantizer 1020 (FIG. 10), for example, to provide a technical solution to support reduced quantization noise.

In one example, based on simulation results for a specific digital system with a medium sampling rate, e.g., a sample rate of about 300 Msps, it may be shown that implementation of the noise-shaping quantizer, e.g., noise-shaping quantizer 1020 (FIG. 10), may provide a technical solution to support a reduction of in quantization noise, e.g., compared to implementations using uniform quantization. In one example, a reduction of about 6 dB-12 dB may be achieved, for example, for various filter orders and/or range processing windows.

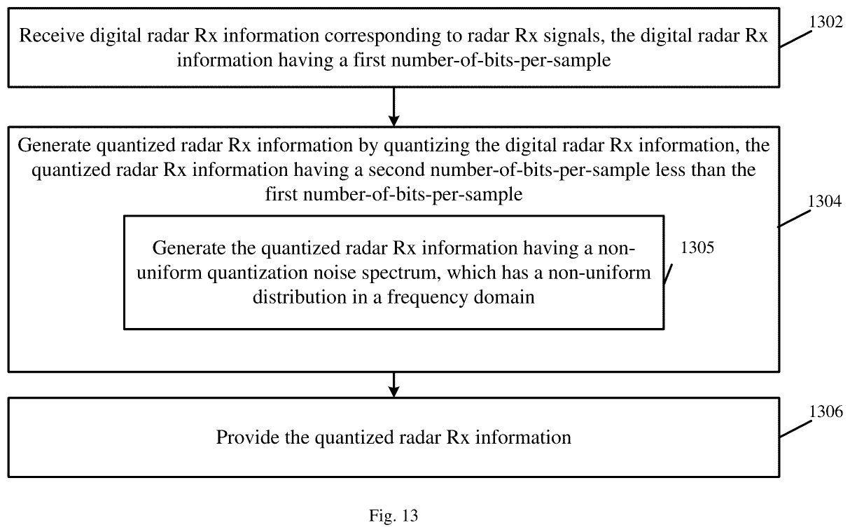

Reference is made to FIG. 13, which schematically illustrates a method of generating quantized radar Rx information, in accordance with some demonstrative aspects. For example, one or more of the operations of the method of FIG. 13 may be performed by a radar system, e.g., radar system 900 (FIG. 9), system 1000 (FIG. 10), and/or system 1200 (FIG. 12); a radar device, e.g., radar device 800 (FIG. 8); a radar front-end, e.g., radar front-end 804 (FIG. 8); an Rx DFE, e.g., Rx DFE 1010 (FIG. 10); and/or a noise-shaping quantizer, e.g., noise-shaping quantizer 1020 (FIG. 10) and/or noise-shaping quantizer 1120 (FIG. 11).

As indicated at block 1302, the method may include receiving digital radar Rx information corresponding to radar Rx signals. For example, the digital radar Rx information may have a first number-of-bits-per-sample. For example, Rx DFE 1010 (FIG. 10) may receive, e.g., via input 1012 (FIG. 10), the digital radar Rx information 1015 (FIG. 10) corresponding to the radar Rx signals 1009 (FIG. 10), e.g., as described above.

As indicated at block 1304, the method may include generating quantized radar Rx information by quantizing the digital radar Rx information. For example, the quantized radar Rx information may have a second number-of-bits-per-sample less than the first number-of-bits-per-sample. For example, noise-shaping quantizer 1020 (FIG. 10) may be configured to generate the quantized radar Rx information 1025 (FIG. 10), for example, by quantizing the digital radar Rx information 1015 (FIG. 10), e.g., as described above.

As indicated at block 1305, generating the quantized radar Rx information may include generating the quantized radar Rx information having a non-uniform quantization noise spectrum, which has a non-uniform distribution in a frequency domain. For example, noise-shaping quantizer 1020 (FIG. 10) may be configured to generate the quantized radar Rx information 1025 (FIG. 10), for example, having a non-uniform quantization noise spectrum, which has a non-uniform distribution in the frequency domain, e.g., as described above.

As indicated at block 1306, the method may include outputting the quantized radar Rx information. For example, Rx DFE 1010 (FIG. 10) may provide, e.g., via output 1016 (FIG. 10), the quantized radar Rx information 1025 (FIG. 10), e.g., as described above.

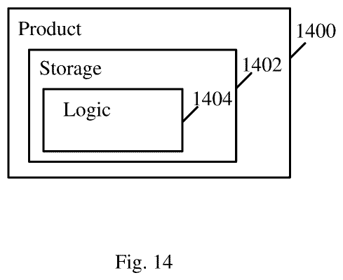

Reference is made to FIG. 14, which schematically illustrates a product of manufacture 1400, in accordance with some demonstrative aspects. Product 1400 may include one or more tangible computer-readable (“machine-readable”) non-transitory storage media 1402, which may include computer-executable instructions, e.g., implemented by logic 1404, operable to, when executed by at least one computer processor, enable the at least one computer processor to implement one or more operations and/or functionalities described with reference to any of the FIGS. 1-13, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1400 and/or machine-readable storage media 1402 may include one or more types of computer-readable storage media capable of storing data, including volatile memory, non-volatile memory, removable or non-removable memory, erasable or non-erasable memory, writeable or re-writeable memory, and the like. For example, machine-readable storage media 1402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1404 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising an input to receive digital radar Receive (Rx) information corresponding to radar Rx signals, the digital radar Rx information having a first number-of-bits-per-sample; a noise-shaping quantizer configured to generate quantized radar Rx information by quantizing the digital radar Rx information, the quantized radar Rx information having a second number-of-bits-per-sample less than the first number-of-bits-per-sample, wherein the noise-shaping quantizer is configured to generate the quantized radar Rx information having a non-uniform quantization noise spectrum, which has a non-uniform distribution in a frequency domain; and an output to provide the quantized radar Rx information.

Example 2 includes the subject matter of Example 1, and optionally, wherein the non-uniform quantization noise spectrum is based on a filter frequency response to be applied to the quantized radar Rx information.

Example 3 includes the subject matter of Example 2, and optionally, wherein the non-uniform quantization noise spectrum is configured such that a filter-convolved noise level of a filter-convolved noise spectrum is less than a quantization-spectrum noise level of the non-uniform quantization noise spectrum, the filter-convolved noise spectrum comprising a convolution of the non-uniform quantization noise spectrum with the filter frequency response.

Example 4 includes the subject matter of Example 2 or 3, and optionally, wherein the non-uniform quantization noise spectrum is configured such that a convolution of the non-uniform quantization noise spectrum with the filter frequency response is to result in a substantially uniform filter-convolved noise spectrum.

Example 5 includes the subject matter of any one of Examples 2-4, and optionally, wherein the filter frequency response to be applied to the quantized radar Rx information comprises a range-processing filter frequency response to be applied to the quantized radar Rx information for radar range processing.

Example 6 includes the subject matter of any one of Examples 2-5, and optionally, wherein the filter frequency response to be applied to the quantized radar Rx information comprises a low-pass filter frequency response.

Example 7 includes the subject matter of any one of Examples 1-6, and optionally, wherein the non-uniform quantization noise spectrum has a high-pass spectrum distribution, which has a form of a high-pass filter frequency response.

Example 8 includes the subject matter of Example 7, and optionally, wherein a high-pass cutoff frequency of the high-pass spectrum distribution is based on a low-pass filter cutoff frequency of a low-pass filter frequency response to be applied to the quantized radar Rx information.

Example 9 includes the subject matter of any one of Examples 1-8, and optionally, wherein the noise-shaping quantizer comprises an information quantizer to generate the quantized radar Rx information by quantizing a quantizer input; and a noise-shaping filter to generate filtered quantization noise by applying a noise-shaping filter frequency response to a quantization error of the information quantizer, wherein the quantizer input is based on the filtered quantization noise and the digital radar Rx information.

Example 10 includes the subject matter of Example 9, and optionally, wherein the noise-shaping filter frequency response is based on a low-pass filter frequency response to be applied to the quantized radar Rx information.

Example 11 includes the subject matter of Example 9 or 10, and optionally, wherein the noise-shaping quantizer comprises an adder to provide the quantizer input by summation of the filtered quantization noise and the digital radar Rx information; and a subtractor to provide the quantization error by subtraction of the quantizer input from the quantized radar Rx information.

Example 12 includes the subject matter of any one of Examples 9-11, and optionally, wherein the noise-shaping filter comprises a non-linear recursive filter.

Example 13 includes the subject matter of any one of Examples 9-12, and optionally, wherein the information quantizer comprises a uniform quantizer to generate the quantized radar Rx information according to a uniform quantization scheme.

Example 14 includes the subject matter of any one of Examples 1-13, and optionally, wherein the non-uniform quantization noise spectrum is based on a predefined filter frequency response.

Example 15 includes the subject matter of any one of Examples 1-14, and optionally, wherein the non-uniform quantization noise spectrum is based on a predefined low-pass filter frequency response.

Example 16 includes the subject matter of any one of Examples 1-15, and optionally, wherein a difference between the first number-of-bits-per-sample and the second number-of-bits-per-sample is at least three.

Example 17 includes the subject matter of any one of Examples 1-16, and optionally, wherein a sample rate of the digital radar Rx information is at least 250 Mega samples per second (Msps).

Example 18 includes the subject matter of any one of Examples 1-17, and optionally, wherein a sample rate of the digital radar Rx information is at least 550 Mega samples per second (Msps).

Example 19 includes the subject matter of any one of Examples 1-18, and optionally, wherein a sample rate of the digital radar Rx information is at least 1000 Mega samples per second (Msps).

Example 20 includes the subject matter of any one of Examples 1-19, and optionally, wherein a data rate of the digital radar Rx information is greater than 25 Giga-bits-per second (Gbps).

Example 21 includes the subject matter of any one of Examples 1-20, and optionally, comprising a radar device, the radar device comprising a transmitter to transmit a plurality of radar Transmit (Tx) signals, a receiver to receive the radar Rx signals based on the plurality of radar Tx pulses, and a radar processor to determine radar information based on the quantized radar Rx information.

Example 22 includes the subject matter of Example 21, and optionally, comprising a vehicle, the vehicle comprising the radar device, and a system controller to control one or more systems of the vehicle based on the radar information.

Example 23 includes an apparatus comprising a Receive (Rx) Digital Front End (DFE) comprising a noise-shaping quantizer configured to generate quantized radar Rx information by quantizing digital radar Rx information corresponding to radar Rx signals, the digital radar Rx information having a first number-of-bits-per-sample, the quantized radar Rx information having a second number-of-bits-per-sample less than the first number-of-bits-per-sample, wherein the noise-shaping quantizer is configured to generate the quantized radar Rx information having a non-uniform quantization noise spectrum, which has a non-uniform distribution in a frequency domain; a processor configured to process the quantized radar Rx information using a low-pass filter; and a communication interface to transfer the quantized radar Rx information to the processor, wherein the noise-shaping quantizer is configured to generate the quantized radar Rx information such that the non-uniform quantization noise spectrum is based on a low-pass filter frequency response of the low-pass filter.

Example 24 includes the subject matter of Example 23, and optionally, wherein the non-uniform quantization noise spectrum is configured such that a filter-convolved noise level of a filter-convolved noise spectrum is less than a quantization-spectrum noise level of the non-uniform quantization noise spectrum, the filter-convolved noise spectrum comprising a convolution of the non-uniform quantization noise spectrum with the low-pass filter frequency response.

Example 25 includes the subject matter of Example 23 or 24, and optionally, wherein the non-uniform quantization noise spectrum is configured such that a convolution of the non-uniform quantization noise spectrum with the low-pass filter frequency response is to result in a substantially uniform filter-convolved noise spectrum.

Example 26 includes the subject matter of any one of Examples 22-25, and optionally, wherein the low-pass filter frequency response comprises a range-processing filter frequency response to be applied to the quantized radar Rx information for radar range processing.

Example 27 includes the subject matter of any one of Examples 23-26, and optionally, wherein the non-uniform quantization noise spectrum has a high-pass spectrum distribution, which has a form of a high-pass filter frequency response.

Example 28 includes the subject matter of Example 27, and optionally, wherein a high-pass cutoff frequency of the high-pass spectrum distribution is based on a low-pass filter cutoff frequency of the low-pass filter frequency response.

Example 29 includes the subject matter of any one of Examples 23-28, and optionally, wherein the noise-shaping quantizer comprises an information quantizer to generate the quantized radar Rx information by quantizing a quantizer input; and a noise-shaping filter to generate filtered quantization noise by applying a noise-shaping filter frequency response to a quantization error of the information quantizer, wherein the quantizer input is based on the filtered quantization noise and the digital radar Rx information.

Example 30 includes the subject matter of Example 29, and optionally, wherein the noise-shaping filter frequency response is based on the low-pass filter frequency response.

Example 31 includes the subject matter of Example 29 or 30, and optionally, wherein the noise-shaping quantizer comprises an adder to provide the quantizer input by summation of the filtered quantization noise and the digital radar Rx information; and a subtractor to provide the quantization error by subtraction of the quantizer input from the quantized radar Rx information.

Example 32 includes the subject matter of any one of Examples 29-31, and optionally, wherein the noise-shaping filter comprises a non-linear recursive filter.

Example 33 includes the subject matter of any one of Examples 29-32, and optionally, wherein the information quantizer comprises a uniform quantizer to generate the quantized radar Rx information according to a uniform quantization scheme.

Example 34 includes the subject matter of any one of Examples 23-33, and optionally, wherein a difference between the first number-of-bits-per-sample and the second number-of-bits-per-sample is at least three.

Example 35 includes the subject matter of any one of Examples 23-34, and optionally, wherein a sample rate of the digital radar Rx information is at least 250 Mega samples per second (Msps).

Example 36 includes the subject matter of any one of Examples 23-35, and optionally, wherein a sample rate of the digital radar Rx information is at least 550 Mega samples per second (Msps).

Example 37 includes the subject matter of any one of Examples 23-36, and optionally, wherein a sample rate of the digital radar Rx information is at least 1000 Mega samples per second (Msps).

Example 38 includes the subject matter of any one of Examples 23-37, and optionally, wherein a data rate of the digital radar Rx information is greater than 25 Giga-bits-per second (Gbps).

Example 39 includes the subject matter of any one of Examples 23-38, and optionally, wherein the communication interface comprises a Serializer/Deserializer (SERDES) interface.

Example 40 includes the subject matter of any one of Examples 23-39, and optionally, comprising a radar device, the radar device comprising a transmitter to transmit a plurality of radar Transmit (Tx) signals, a receiver to receive the radar Rx signals based on the plurality of radar Tx pulses, and a radar processor to determine radar information based on the quantized radar Rx information.

Example 41 includes the subject matter of Example 40, and optionally, comprising a vehicle, the vehicle comprising the radar device, and a system controller to control one or more systems of the vehicle based on the radar information.

Example 42 includes a radar device comprising the subject matter of any of Examples 1-41.

Example 43 includes a vehicle comprising the subject matter of any of Examples 1-41.

Example 44 includes an apparatus comprising means for performing any of the described operations of any of Examples 1-41.

Example 45 includes a machine-readable medium that stores instructions for execution by a processor to perform any of the described operations of any of Examples 1-41.

Example 46 comprises a product comprising one or more tangible computer-readable non-transitory storage media comprising instructions operable to, when executed by at least one processor, enable the at least one processor to cause a device and/or system to perform any of the described operations of any of Examples 1-41.

Example 47 includes an apparatus comprising a memory; and processing circuitry configured to perform any of the described operations of any of Examples 1-41.

Example 48 includes a method including any of the described operations of any of Examples 1-41.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
an input to receive digital radar Receive (Rx) information corresponding to radar Rx signals, the digital radar Rx information having a first number-of-bits-per-sample;
a noise-shaping quantizer configured to generate quantized radar Rx information by quantizing the digital radar Rx information, the quantized radar Rx information having a second number-of-bits-per-sample less than the first number-of-bits-per-sample, wherein the noise-shaping quantizer is configured to generate the quantized radar Rx information having a non-uniform quantization noise spectrum, which has a non-uniform distribution in a frequency domain; and
an output to provide the quantized radar Rx information.

2. The apparatus of claim 1, wherein the non-uniform quantization noise spectrum is based on a filter frequency response to be applied to the quantized radar Rx information.

3. The apparatus of claim 2, wherein the non-uniform quantization noise spectrum is configured such that a filter-convolved noise level of a filter-convolved noise spectrum is less than a quantization-spectrum noise level of the non-uniform quantization noise spectrum, the filter-convolved noise spectrum comprising a convolution of the non-uniform quantization noise spectrum with the filter frequency response.

4. The apparatus of claim 2, wherein the non-uniform quantization noise spectrum is configured such that a convolution of the non-uniform quantization noise spectrum with the filter frequency response is to result in a substantially uniform filter-convolved noise spectrum.

5. The apparatus of claim 2, wherein the filter frequency response to be applied to the quantized radar Rx information comprises a range-processing filter frequency response to be applied to the quantized radar Rx information for radar range processing.

6. The apparatus of claim 2, wherein the filter frequency response to be applied to the quantized radar Rx information comprises a low-pass filter frequency response.

7. The apparatus of claim 1, wherein the non-uniform quantization noise spectrum has a high-pass spectrum distribution, which has a form of a high-pass filter frequency response.

8. The apparatus of claim 7, wherein a high-pass cutoff frequency of the high-pass spectrum distribution is based on a low-pass filter cutoff frequency of a low-pass filter frequency response to be applied to the quantized radar Rx information.

9. The apparatus of claim 1, wherein the noise-shaping quantizer comprises:
an information quantizer to generate the quantized radar Rx information by quantizing a quantizer input; and
a noise-shaping filter to generate filtered quantization noise by applying a noise-shaping filter frequency response to a quantization error of the information quantizer, wherein the quantizer input is based on the filtered quantization noise and the digital radar Rx information.

10. The apparatus of claim 9, wherein the noise-shaping filter frequency response is based on a low-pass filter frequency response to be applied to the quantized radar Rx information.

11. The apparatus of claim 9, wherein the noise-shaping quantizer comprises:
an adder to provide the quantizer input by summation of the filtered quantization noise and the digital radar Rx information; and
a subtractor to provide the quantization error by subtraction of the quantizer input from the quantized radar Rx information.

12. The apparatus of claim 9, wherein the noise-shaping filter comprises a non-linear recursive filter.

13. The apparatus of claim 9, wherein the information quantizer comprises a uniform quantizer to generate the quantized radar Rx information according to a uniform quantization scheme.

14. The apparatus of claim 1, wherein the non-uniform quantization noise spectrum is based on a predefined low-pass filter frequency response.

15. The apparatus of claim 1, wherein a difference between the first number-of-bits-per-sample and the second number-of-bits-per-sample is at least three.

16. The apparatus of claim 1, wherein a data rate of the digital radar Rx information is greater than 25 Giga-bits-per second (Gbps).

17. An apparatus comprising:
a Receive (Rx) Digital Front End (DFE) comprising a noise-shaping quantizer configured to generate quantized radar Rx information by quantizing digital radar Rx information corresponding to radar Rx signals, the digital radar Rx information having a first number-of-bits-per-sample, the quantized radar Rx information having a second number-of-bits-per-sample less than the first number-of-bits-per-sample, wherein the noise-shaping quantizer is configured to generate the quantized radar Rx information having a non-uniform quantization noise spectrum, which has a non-uniform distribution in a frequency domain;
a processor configured to process the quantized radar Rx information using a low-pass filter; and
a communication interface to transfer the quantized radar Rx information to the processor,
wherein the noise-shaping quantizer is configured to generate the quantized radar Rx information such that the non-uniform quantization noise spectrum is based on a low-pass filter frequency response of the low-pass filter.

18. The apparatus of claim 17, wherein the non-uniform quantization noise spectrum is configured such that a filter-convolved noise level of a filter-convolved noise spectrum is less than a quantization-spectrum noise level of the non-uniform quantization noise spectrum, the filter-convolved noise spectrum comprising a convolution of the non-uniform quantization noise spectrum with the low-pass filter frequency response.

19. The apparatus of claim 17, wherein the non-uniform quantization noise spectrum is configured such that a convolution of the non-uniform quantization noise spectrum with the low-pass filter frequency response is to result in a substantially uniform filter-convolved noise spectrum.

20. The apparatus of claim 17, wherein the low-pass filter frequency response comprises a range-processing filter frequency response to be applied to the quantized radar Rx information for radar range processing.

21. The apparatus of claim 17, wherein the non-uniform quantization noise spectrum has a high-pass spectrum distribution, which has a form of a high-pass filter frequency response.

22. The apparatus of claim 21, wherein a high-pass cutoff frequency of the high-pass spectrum distribution is based on a low-pass filter cutoff frequency of the low-pass filter frequency response.

23. The apparatus of claim 17, wherein the noise-shaping quantizer comprises:
an information quantizer to generate the quantized radar Rx information by quantizing a quantizer input; and
a noise-shaping filter to generate filtered quantization noise by applying a noise-shaping filter frequency response to a quantization error of the information quantizer, wherein the quantizer input is based on the filtered quantization noise and the digital radar Rx information.

24. The apparatus of claim 17, wherein a data rate of the digital radar Rx information is greater than 25 Giga-bits-per second (Gbps).

25. The apparatus of claim 17 comprising a radar device, the radar device comprising a transmitter to transmit a plurality of radar Transmit (Tx) signals, a receiver to receive the radar Rx signals based on the plurality of radar Tx pulses, and a radar processor to determine radar information based on the quantized radar Rx information.

26. The apparatus of claim 25 comprising a vehicle, the vehicle comprising the radar device, and a system controller to control one or more systems of the vehicle based on the radar information.
